(19) United States
(12) Patent Application Publication
(10) Pub. No.: US 2022/0374911 A1
(43) Pub. Date: Nov. 24, 2022

(54) icon-based compliance as a service

(71) Applicant: David Lee Jones, JR., Orange Park, FL (US)

(72) Inventor: David Lee Jones, JR., Orange Park, FL (US)

(21) Appl. No.: 17/327,688

(22) Filed: May 22, 2021

(51) Int. Cl. G06Q 30/00; G06K 7/14

(52) U.S. Cl. CPC G06Q 30/018; G06K 7/1417

(57) ABSTRACT

This disclosure relates generally to a system and method for the presentation of programmatic interface for creating a static badge/icon/image, with an embedded dynamic report system that can display different types of information. Primary use case is providing compliance-related data, such as a verified accomplishment or achievement suitable for public display. Alternatively, can be used to display various information either static by nature or dynamic based on the nature of the data. This approach is suitable individuals or company that wishes to have specific compliance-related or achievement captured and displayed though an icon.

### COPYRIGHT NOTICE

A portion of the disclosure of this patent document contains material which is subject to copyright protection. The copyright owner has no object to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention relates to a regulatory compliance system and a method and system for perpetual compliance auditing. Particularly, the invention is directed to a web-based system of auditing compliance with rules and regulations for industries subject to federal, state and local agencies, industry association standards and company policies.

### Description of the Related Art

A myriad of ever-changing rules and regulations apply to most businesses and organizations, especially those that affect the environment or public safety. Many of the rules and regulations may be statutory when emanating from federal, state and local governments. Rules also emanate from industry organizations, such as the American Petroleum Institute (hereinafter, API), as well as a company's own policies and procedures. Automated systems of integrated computer programs for facilitating compliance with government rules and regulations are available for various government and industry organizations. Generally, pertinent references in this field relate to one of three categories: 1) systems for managing compliance with regulatory entities and/or equipment, 2) systems and methods for determining compliance with government regulations for chemical products and 3) tracking systems to determine compliance requirements for hazardous materials as part of an overall management system.

In U.S. Pat. No. 6,292,806, Sandifer discloses a computer-based maintenance and repair information system for equipment subject to regulatory compliance, specifically for aircraft. The technical database comprises electronically stored publications and maintenance information for aircraft and components. The status of compliance with Airworthiness Directives and manufacturer service information is maintained for each component, allowing users to determine whether or not an aircraft is in compliance with airworthiness regulations. In the '806 patent, the maintenance and repair information may be on different CD-ROM discs and there is no electronic commingling of publications, see Col. 22, lines 5-14. Each publication must be individually searched for data regarding a specific component.

The next group of disclosed patents relate to systems for compliance of chemical products. Petke et al. in U.S. Pat. No. 6,163,732 disclose a system, method and computer program for determining compliance of chemical products to governmental regulations. The chemical composition present in the chemical product to be manufactured is ascertained and compared to a stored set of government regulatory standards related to the chemical composition so that compliance can be determined. The regulatory databases are maintained and updated. The chemical composition is determined from manufacturing bills of materials. In U.S. Pat. No. 6,097,995 to Tipton et al., a hazardous materials and waste reduction management system is disclosed. The chemical management system includes a chemical inventory control system allowing a user to manage chemicals from a central station, to allow for the tracking of individual chemical containers throughout its life and an international chemical compatibility system with a compliance/education design to create compliance/education files for any country in the world. The system includes international hazardous material compatibility data stored on a computer for multi-tier compliance/education design data for creating files in any foreign language. The compliance data for chemicals is printed onto labels as well as compliance data for related safety equipment. The data represents a comparison of sampled data from an item of safety equipment compared to a set of standard criteria for performance of the item.

Wiitala et al., U.S. Pat. No. 6,122,622 disclose a computer aided system for compliance with chemical control laws. The system comprises a means for storing compliance information for substances; based on substance control laws of different jurisdictions having varying requirements and means for processing and program instructions to determine the compliance status for a product, based on the compliance information. This system is limited to chemical control law compliance.

There are multiple inventions that: have been proposed in prior art regarding Compliance reporting and management system. However, the utility of these systems has not been seen in advance form and for specialized needs. Currently the volume of government and industry regulatory requirements for a company's plants, equipment and personnel is continuously growing, constantly c hanging, and difficult to track. None of the above-referenced patents discuss or resolve the problem of having to continuously update rules and regulations. Nor do any discuss or teach the importance of periodically reviewing a company or organization's compliance with all the rules, regulations and recommended procedures that emanate from the multitude of regulatory entities.

The current invention proposes a system where a new approach, utilizing the best of breed in existing technologies, to revolutionize the digital arena, implementing the bridge that fills the gap between compliance reporting and ease of use and implementation.

The proposed platform seeks to significantly simplify the whole process and efficiently manages the circumstances through its swift ability. The invention relates to the development of a worlds first icon-based compliance framework. It aims to combine elegant design with enterprise-grade security and dynamic compliance reporting functionality. It provides Managed Service Providers (MSP) the perfect customer-facing solution to re-emphasize existing value in both initial and ongoing compliance monitoring for GDPR, SOC, HIPPA and others. User can select the compliance icon, identified by the word “compli-con”, and identify the compliance type and certification period, and can get compliance icon with dynamic reporting generated in minutes. Additionally, invention uses proprietary system where embedded QR code changes colors based on compliance, providing a visual aid regarding compliance in addition to reporting features.

As per applicants' knowledge, none of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description A full appreciation of the various aspects of the invention can be gained by taking the entire specification, claims, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of an automated icon-based framework which combines elegant design with enterprise-grade security and dynamic compliance reporting functionality.

It is also the objective of the invention to provide a simplified process of Programmatic interface for creating a static badge/icon/image, with an embedded dynamic report system that can display different types of compliance information, as well as visually represent, by colors, whether compliance is current.

It is moreover the objective of the invention to provide a compliance-related data, such as a verified accomplishment or achievement suitable for public display. The invention can be for icon-based compliance as a service, icon-based compliance-as-a-platform, i-compli framework, QR Code-based dynamic compliance reporting.

It is also the objective of the invention to provide a system which has provision to display various information either static by nature or dynamic based on the nature of the data.

It is further the objective of the invention to provide a dual and reliable system which is easy to use and is easily compatible for all types of smart devices.

It is moreover the objective of the invention to provide a system which is in line with latest regulatory information and utilizes the latest regulatory information system including but not limited to real time environment, a highly compatible and artificial intelligence-based system is introduced.

It is further the objective of the invention to provide an interface which is easy to use, and where new users are provided with necessary guidance to use the system.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an icon-based compliance framework. icompli combines elegant design with enterprise-grade security and dynamic compliance reporting functionality.

This invention relates to an innovative regulatory compliance system for an organization or company to continuously track the multitude of rules and regulations emanating from state and federal agencies, industry standards, watchdog organizations and the organization's own policies and procedures to ensure that the rules and regulations remain evergreen. The method and system perpetually monitor and report the organization's compliance with the updated rules and regulations so that a compliance system and perpetual audit manual is generated. The compliance system and manual can be available to authorized users online or in any electronic or hard copy format.

The proposed method for compliance auditing comprises providing a secured, interactive web-based system. Accessibility to the web-based system is limited to authorized users. Subject items, that is, items subject to rules and regulations emanating from various government and industry entities, can include facility sites, assets such as equipment located at the facility sites, operational activities occurring at the sites and even personnel that are subject to government regulations, OSHA for example. During the method of this invention, the subject items specifically applicable to an authorized user are identified. The regulatory compliance requirements that are applicable for substantially each identified subject item are then determined. These regulations are continuously updated to remain evergreen.

The current invention as per its preferred embodiments provides a system where as per its preferred embodiments provides a programmatic interface for creation of a static badge/icon/image, with an embedded dynamic report system that can display different types of information.

The primary advantage of the proposed assembly presents compliance-related data, such as a verified accomplishment or achievement suitable for public display.

As per additional embodiments of invention, the smart algorithms can be used to display various information either static by nature or dynamic based on the nature of the data. The invention can be for icon-based compliance as a service, icon-based compliance-as-a-platform, i-compli framework, QR Code-based dynamic compliance reporting.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for compliance auditing comprising:
(a) providing a secured, interactive web-based system, accessibility to the web-based system limited to authorized users;
(b) a static badge/icon/image, with an embedded dynamic report system that can display different types of information.
(c) determining regulatory compliance requirements applicable for substantially each subject item identified in step (b);
(d) providing compliance requirements reports comprising specific subject items and their related regulatory compliance requirements to one or more persons responsible for compliance;

2. The method of claim 1 wherein the web-based system is accessible on the World Wide Web.

3. The method of claim 1 wherein the subject items comprise facility sites, equipment located at the facility sites and operational activities occurring on the sites, the facility sites, equipment and operational activities being subject to regulatory compliance.

4. The method of claim 1 wherein the facility site comprises land, structures and buildings on the land, and personnel located at the facility site.

5. The method of claim 1 wherein regulatory compliance data comprises a summary of applicable and potentially applicable compliance requirements data for each subject item, the compliance requirements data emanating from one or more laws, statutory codes, government rules, regulations, permit requirements, required tasks, required actions associated with rules and regulations, standards, policies, procedures and guidelines of one or more regulatory authorities.

6. The method of claim 5 wherein the one or more regulatory authorities comprise government legislatures, government agencies, industry associations, and company organizations.
